(19) United States
(12) Patent Application Publication
(10) Pub. No.: US 2014/0146155 A1
(43) Pub. Date: May 29, 2014

(54) Image Processing

(71) Applicant: Novarad Corporation, American Fork, UT (US)

(72) Inventors: Wendell Arlen Gibby, Mapleton, UT (US); Steven Todd Cvetko, Draper, UT (US)

(73) Assignee: Novarad Corporation, American Fork, UT (US)

(21) Appl. No.: 14/088,286

(22) Filed: Nov. 22, 2013

Related U.S. Application Data
(60) Provisional application No. 61/729,582, filed on Nov. 24, 2012.

(51) Int. Cl. G06K 9/32

(52) U.S. Cl. CPC G06K 9/32
USPC 348/77; 382/128

(57) ABSTRACT

An image processing method may include capturing images of a subject using an image capture device. The images may be aligned and one image may be subtracted from another to obtain a remainder image. The remainder image may be marked and then recombined with one of the images.

### PRIORITY CLAIM

Priority is claimed to U.S. Provisional Patent Application Ser. No. 61/729,582, filed Nov. 24, 2012, which is hereby incorporated herein by reference in its entirety.

### BACKGROUND

Various medical imaging systems have been developed to image portions of a human body. Such medical imaging systems have been enabled to generate digital medical images of the body. Some example technologies for medical imaging include x-ray, CT (Computed Tomography), CR (Computed Radiography), FPD (Flat Panel Detector), MRI (Magnetic Resonance Imaging) and so forth.

Captured medical images may be made available to a medical professional for evaluation or diagnosis. The medical professional may view the medical images using a display device and may be able to store notes and other evaluation data with the medical images.

The quality of medical images may be affected by a variety of factors. A low or reduced quality of the images may lead to an incomplete or inaccurate diagnosis by the medical professional. Similarly, movement of the subject during imaging may cause issues with clarity of the images. For example, blurriness, graininess, discoloration, image artifacts and so forth may increase the difficulty of accurately diagnosing a condition using images with such defects or problematic quality. An improvement in medical images may increase the accuracy of diagnoses and make the medical images easier to evaluate for the medical professional.

### BRIEF DESCRIPTION OF THE DRAWINGS

FIG. 1 is an image of a top view of a skull in accordance with an example of the present technology;

FIG. 2 is an image of a top view of a skull with a marking fluid inserted into the blood vessels within the skull in accordance with an example of the present technology; and

FIG. 3 is a remainder image obtained by subtracting the image of FIG. 1 from the image of FIG. 2 in accordance with an example of the present technology;

FIG. 4 illustrates a view of the remainder image during a processing step for registration of the images of FIGS. 1 and 2 in accordance with an example of the present technology;

FIG. 5 is a remainder image obtained by subtracting the image of FIG. 1 from the image of FIG. 2 after alignment in accordance with an example of the present technology

FIG. 6 is a combined image of a colorized remainder image of FIG. 5 with the image of FIG. 2 in accordance with an example of the present technology;

FIG. 7 is a combined image of a colorized remainder image of FIG. 3 with the image of FIG. 2 in accordance with an example of the present technology;

FIGS. 8a-8e include the images of FIGS. 1-5 at the right side of the figures, with features shown to the left side of the figures to illustrate steps of a registration process in accordance with an example of the present technology;

FIG. 9 is a flow diagram of an image processing method including alignment of images in accordance with an example of the present technology;

FIG. 10 is a flow diagram of an image processing method including colorization of a remainder image in accordance with an example of the present technology; and

FIG. 11 is a block diagram of an image registration system in accordance with an example of the present technology.

### DETAILED DESCRIPTION

Reference will now be made to the examples illustrated, and specific language will be used herein to describe the same. It will nevertheless be understood that no limitation of the scope of the technology is thereby intended. Additional features and advantages of the technology will be apparent from the detailed description which follows, taken in conjunction with the accompanying drawings, which together illustrate, by way of example, features of the technology.

### DEFINITIONS

It is noted that, as used in this specification and the appended claims, the singular forms “a,” “an,” and “the” include plural referents unless the context clearly dictates otherwise.

As used herein, the terms “about” and “approximately” are used to provide flexibility, such as to indicate, for example, that a given value in a numerical range endpoint may be “a little above” or “a little below” the endpoint. The degree of flexibility for a particular variable can be readily determined by one skilled in the art based on the context.

As used herein, the term “substantially” refers to the complete or nearly complete extent or degree of an action, characteristic, property, state, structure, item, or result. The exact allowable degree of deviation from absolute completeness may in some cases depend on the specific context. However, the nearness of completion will generally be so as to have the same overall result as if absolute and total completion were obtained. The use of “substantially” is equally applicable when used in a negative connotation to refer to the complete or near complete lack of an action, characteristic, property, state, structure, item, or result.

As used herein, a plurality of components may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

### EXAMPLES OF THE TECHNOLOGY

It is noted in the present disclosure that when describing the system, or the related devices or methods, individual or separate descriptions are considered applicable to one other, whether or not explicitly discussed in the context of a particular example or embodiment. For example, in discussing a device per se, other devices, systems, and/or method embodiments are also included in such discussions, and vice versa.

Furthermore, various modifications and combinations can be derived from the present disclosure and illustrations, and as such, the following figures should not be considered limiting.

Medical imaging systems may be used to capture multiple images over time. Because of a lapse in time between images, a subject or human may move or adjust a position of the portion of the body being imaged. When the subject moves, the medical professional evaluating the images expends additional effort in tracking features in the images which may be in a different place on a display screen from one image to the next. Furthermore, such movement may increase the complexity of highlighting desired portions of the image for review and evaluation.

An image processing method in accordance with an example of the present technology may include capturing images of a subject over time using an image capture device. The images may be aligned and one image may be subtracted from another to obtain a remainder image. The remainder image may be marked and then recombined with one of the images.

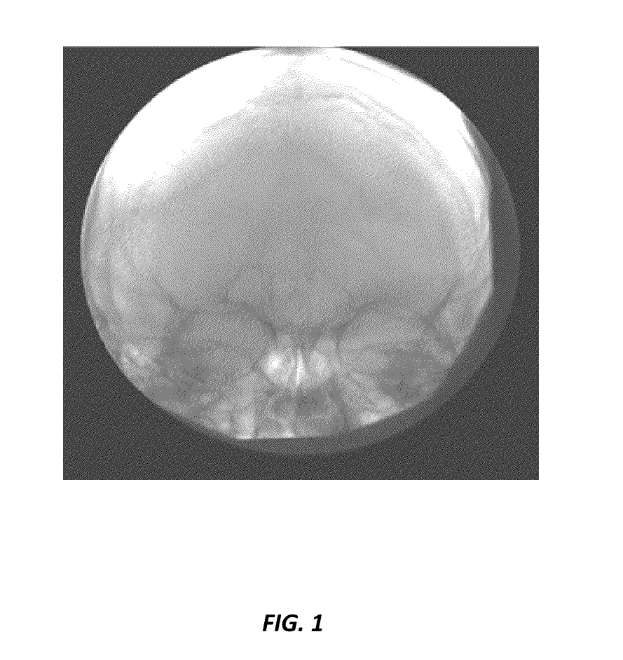

Referring to FIG. 1, an image of a top view of a skull is illustrated. This image may be a base image used for comparison with subsequent images. Features of the skull and/or brain, blood vessels and so forth within the skull may be discernable in the image.

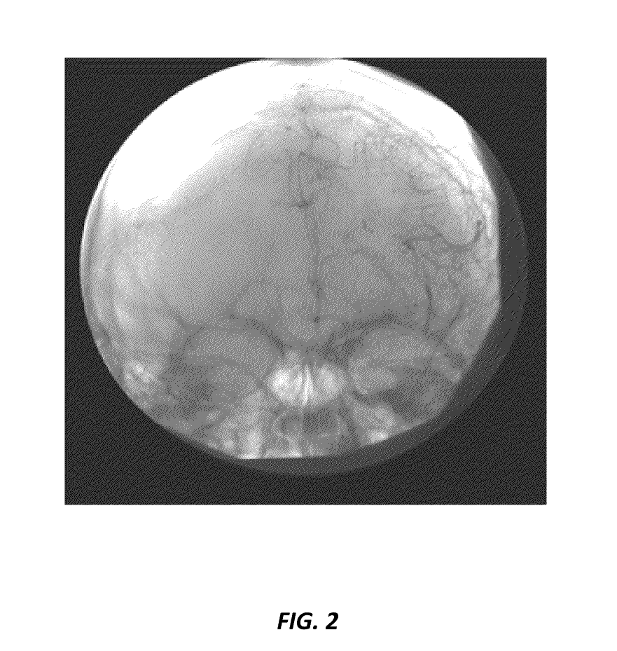

Referring to FIG. 2, a second image of a top view of a skull is illustrated. In this example, blood that has been “marked” is flowing in the blood vessels. For example, the blood may be marked by introducing a chemical compound configured to enhance the visibility of the blood (or the flow thereof) using the medical imaging system. Various types of blood marking compounds exist and may be readily used for this purpose.

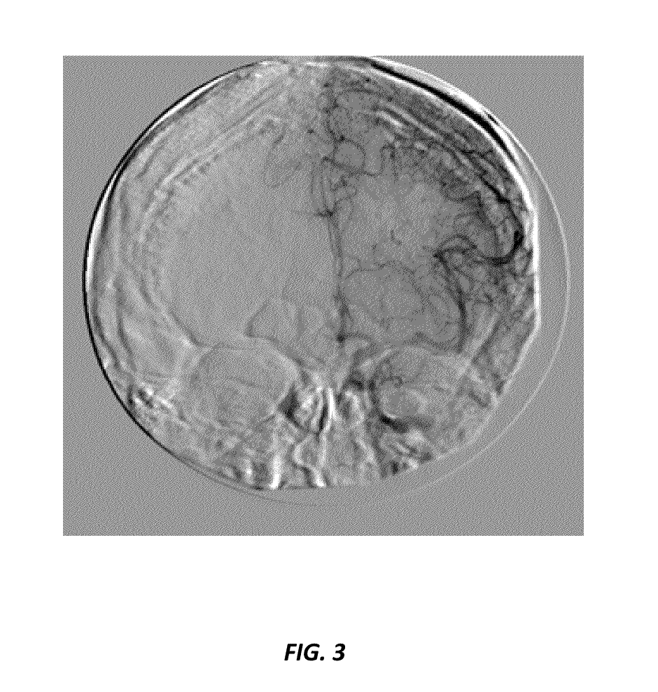

Referring to FIG. 3, a third image of a top view of a skull is illustrated. Rather than a directly captured image, as with the images in FIGS. 1-2, the image of FIG. 3 represents a difference between two images. In other words, one image has been subtracted from the other. In this case, the first or base image (FIG. 1) has been subtracted from the second image (FIG. 2) to obtain a remainder image (FIG. 3). Subtracting one image from the other may highlight differences between the images. Image subtraction or pixel subtraction may be a process whereby the digital numeric value of one pixel or whole image is subtracted from another image for detecting changes between two images. One of the differences between the first and second images may be the introduction of the marking compound to view the blood flow, resulting in a different visible blood flow pattern between the first and second images. Many other aspects of the first and second images may be similar. Thus, by subtracting one image from the other, differences in the images may become more visible.

In an ideal example, the subtraction of one image from the other may result in the blood flow being visible while other aspects of the image are removed. One example assumes, for example, that the first and second images are aligned and that no changes other than the flow of blood with the marking compound have occurred. However, even slight movement of the subject, for example, may result in discrepancies between the first and second images. Specifically, because the subject moved slightly between the capture of the first and second images, artifacts may be visible in the remainder image.

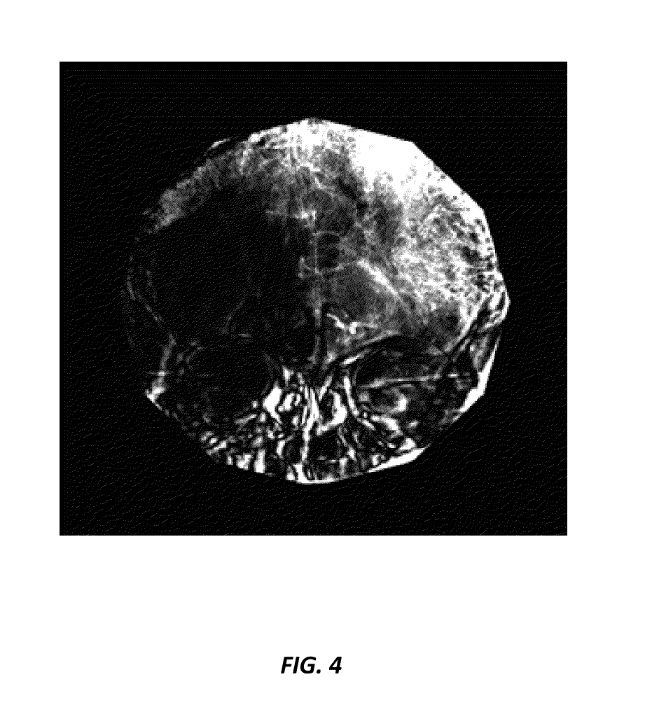

To accommodate for movement of features in the images between capture of the first image and capture of the second image, the images may be aligned using an image registration method. FIG. 4 illustrates a view of the remainder image during processing using the registration method. The view of FIG. 4 illustrates an image where the square of the difference of the first and second images is calculated. The “bright” or white regions may be areas of significant difference between the first and second images. An N-dimensional binary search may be performed to find the optimal fit. The optimal fit may be, for example, where the area of the bright regions is minimized. Because the bright regions represent differences between the images, an orientation of the images with a lowest number or area of bright regions may represent a best fit alignment. Images that are not well-aligned may result in a greater number or larger area of bright regions because the differences between the images are increased as compared with the aligned images. Additional examples regarding registration of the images will be provided below.

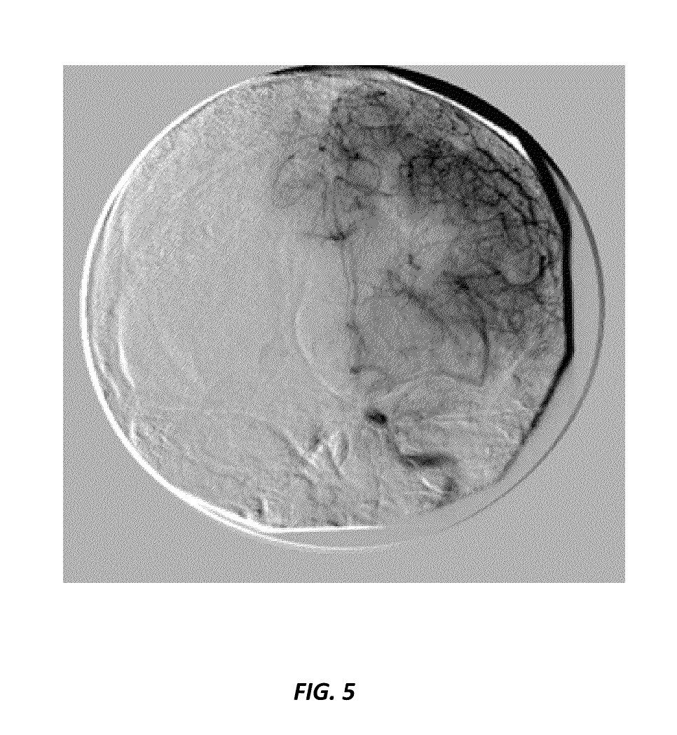

FIG. 5 illustrates a remainder image of a top view of a skull. This image, similar to the image illustrated in FIG. 3, represents a subtraction of the first image from the second image. However, the remainder image in FIG. 5 has been obtained after registration of the first and second images. In other words, the first and second images were aligned, then subtracted one from another. The quality of the remainder image in FIGS. 3 and 5 may be improved using alignment. Image artifacts are significantly reduced and there is a marked improvement in clarity and detail of the flow of the blood with the marking compound through the blood vessels.

The remainder image of FIG. 5 may be combined with or overlayed on the first or second images to improve the visibility of the blood flow in the first or second images. In one aspect, a contrast ratio of the remainder image may be adjusted to further emphasize the areas of blood flow and deemphasize or remove image artifacts. In other words, the remainder image may be “marked” such that the regions of interest are made more visible.

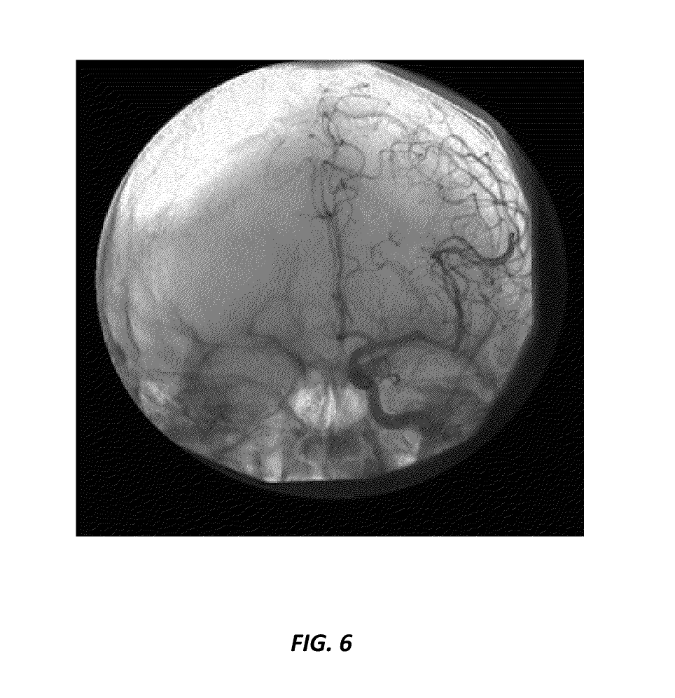

FIG. 6 illustrates an example marked image. In this example, the remainder image has been colorized. Colorization may include applying any color to the remainder image, including the addition or enhancement of colors already present in the remainder image (such as black, gray, white, etc.). In this example, the blood vessels in the remainder image have been colored red to provide a highly visible distinction between the blood flow and the rest of the image. For example, the remainder image may be analyzed using a processor to identify areas of the remainder image with a specific color or within a predetermined range of variation of a specific color. The remainder image in FIG. 5 results in blood flow being shown in dark colors while image artifacts are a light or even white color. Thus, identification of the dark areas for colorization may result in colorization of the regions of interest while avoiding colorization of other areas of the image.

In one example, the marked remainder image may be used or viewed for evaluation as a standalone image independent of the first or second images. However, overlaying the marked remainder image over the first or second images enables the medical professional to view the original image with anatomical landmarks with the changes to the image (i.e., the flow of blood) highlighted through colorization or the like.

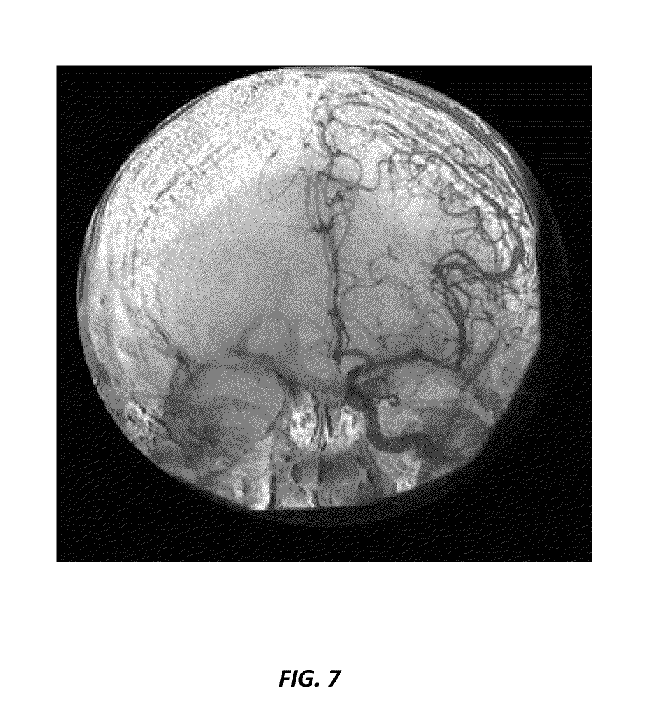

In another example shown in FIG. 7, the remainder image from FIG. 3 has been marked or colorized and combined with the first or second images. In this image, some of the artifacts of FIG. 3 have been colorized as well, albeit with a different color (i.e., blue). A system may recognize changes from one image to the next and may further recognize consistency of changes or type of changes. For example, changes in images due to the marked blood may result in a different appearance than changes as a result of artifacts, such as appearing as a different shade of color than the artifacts. An image processing system may automatically choose one of the colorized portions based on predetermined factors such as an expected color shade for blood, for example, or may present both the actual changes and the artifacts to an operator and enable the operator to select which color(s) to keep marked and which to discard. While the image of FIG. 7 includes the artifacts and is overall a lower quality of image compared with the image of FIG. 6, the colorization may still be valuable to a medical professional. In other words, the technology may optionally include marking the image without performing registration to enhance visibility of the features in the image for evaluation.

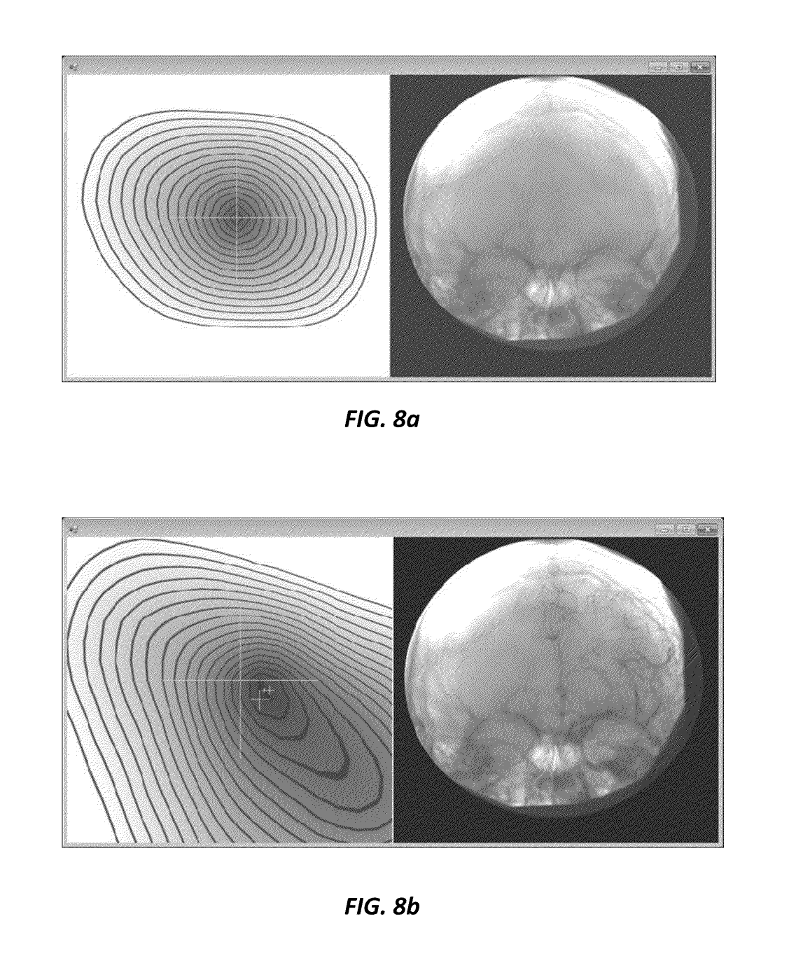

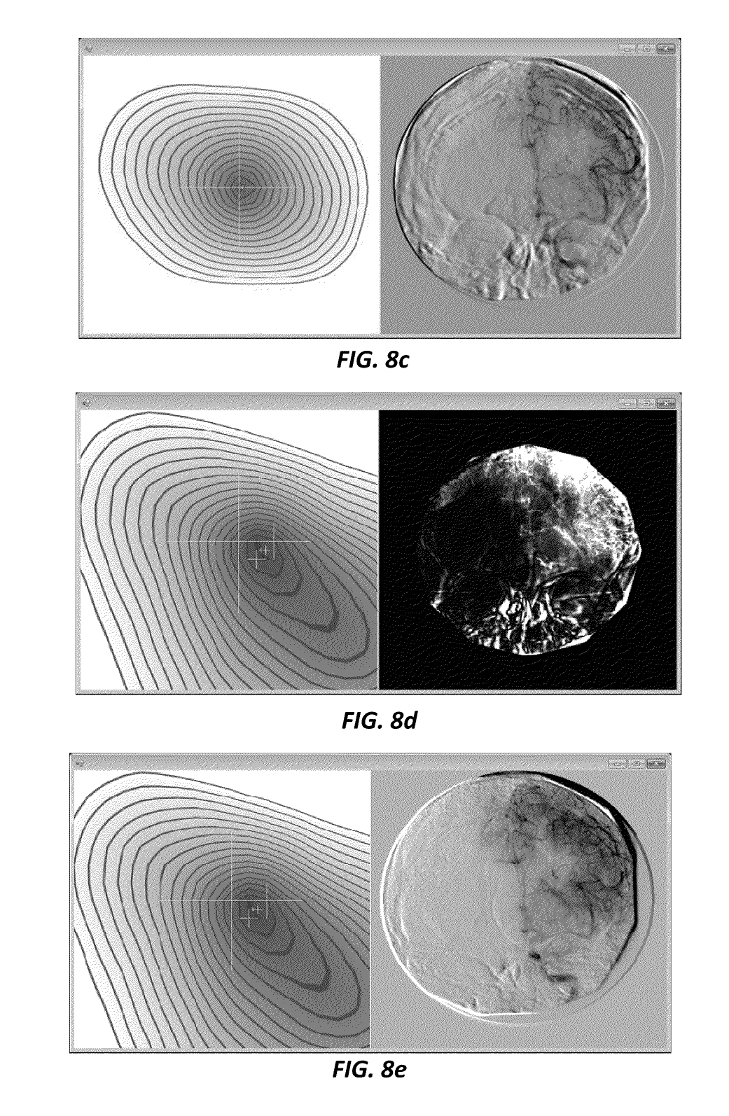

FIGS. 8a-8e include the images of FIGS. 1-5 at the right side of the figures, with explanatory features shown to the left side of the figures. The yellow crosses illustrate steps taken for image registration. In other words, the crosses are used to illustrate two-dimensional shifting (translation) that may be performed in finding the optimal fit between the images. The endpoints of each cross represent an attempted “fit”. A best fit process may cause a shift of half the distance between endpoints of the different crosses toward one another, for example. The process may then be repeated at half the scale of the first fit attempt, until an optimal position is found. The shaded region with the blue contour lines show the results if every possible position is tested. The blue contour lines represent a brute-force approach, which may take some time to complete. The darker shaded gray regions are a better fit than lighter or white regions, and may show that the process is working.

A variety of other image registration techniques or processes may be used. For example, image registration may be intensity-based or feature-based. One of the images may be a base image and a second image may be a target image. Image registration may involve spatially transforming the target image to align with the base image. Intensity-based image registration may involve comparison of intensity patterns in images using correlation metrics.

Further, feature-based image registration may analyze the images for correspondence between features of the images such as structures, points, lines, colors, contours and so forth. For example, a known feature, such as a bone or other easily identifiable object in the image, may be used as an anchor feature to start the registration process. The anchor feature may first be aligned and then the image translation, rotation and/or warping may occur with respect that anchor feature. Another type of feature based alignment can use a perimeter of a structure being imaged. For example, the perimeter of a human skull may be identified and then the image alignment may take place between the images with respect to the perimeter of the skull or other identified structure.

Image registration may include linear transformations such as rotation, scaling and other affine transforms. Image registration may also include ‘elastic’ or ‘nonrigid’ transformations. Such transformations may include, for example, locally warping the target image to align with the base image. Some specific examples of nonrigid transformations may include physical continuum models such as for viscous fluids, and large deformation models such as diffeomorphisms, and radial basis functions such as thin-plate or surface splines, multiquadrics and compactly-supported transformations.

Image registration may be performed in a variety of ways. For example, a medical imaging system may include tools to align the images manually. As another example, the medical imaging system may enable interactive image registration which may reduce user bias by performing certain identified operations automatically while relying on the user to guide the registration. Semi-automatic image registration may include the performance of many of the registration steps automatically but may still rely on the user to verify the correctness of a registration. Automatic registration may be performed automatically without user interaction.

The examples of image registration technologies described above are intended to be non-limiting, and other methods of image registration or alignment which may be applicable to the present technology are also considered to be within the scope of this disclosure.

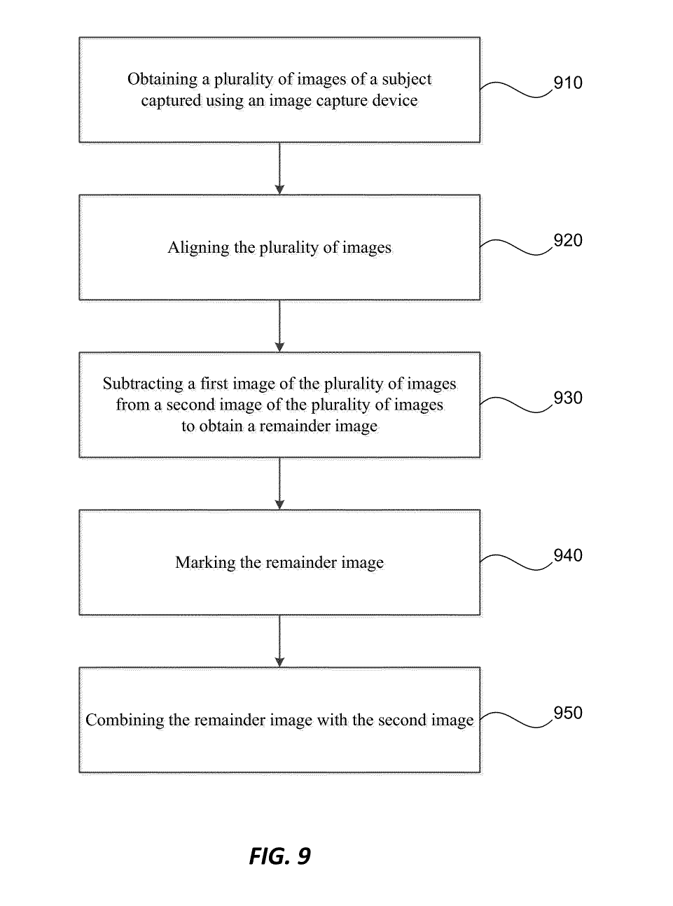

Referring to FIG. 9, a flow diagram of a method of an image processing method is illustrated in accordance with an example of the present technology. The method may include capturing 910 a plurality of images of a subject using an image capture device. Any of a variety of forms of image capture devices may be used, and the specific type of image capture device is not particularly limited. For example, radiography, computed tomography (CT), ultrasound and other technologies may be used to capture images of the subject.

The captured images may be aligned 920, such as by using a least squares fit where a square of the difference between the images is calculated and the images are positioned to minimize the difference.

The method may include subtracting 930 a first image of the plurality of images from a second image of the plurality of images to obtain a remainder image. In an image sequence of two images, the second image may be subtracted from the first. However, when a sequence of images includes more than two images, variations in the approach may be performed. For example, where the plurality of images includes at least three images, the first image may be subtracted from an Nth image (or later image) to obtain a remainder image. The remainder image representing the difference between the first and Nth images may illustrate, for example, the flow of fluid at the time the Nth image was captured and may illustrate a current state of the flow of fluid as compared with the time the first image was captured. The remainder image may be marked and combined with the Nth image. In an example playback of a sequence of images, the first image may be shown, followed by the second image combined with the remainder image from the difference of the first and second images, followed by the third image combined with the remainder image from the difference of the first and third images.

The method may further include marking 940 the remainder image and combining 950 the remainder image with the second or Nth image.

In one example, where the plurality of images includes at least three images, the second image may be subtracted from a third image (e.g., N−(N−1)) to obtain a remainder image, rather than subtracting the first image from the third image (e.g., N−1) as in the example above. The remainder image representing the difference between the second and third images may illustrate, for example, the flow of fluid at the time the third image was captured and may illustrate a current state of the flow of fluid as compared with the time the second image was captured. Also, whereas subtracting the first image from the third image may illustrate the changes in the third image from the original state in the first image, subtracting the second image from the third image may illustrate the changes between the second and third images while de-emphasizing the changes that occurred between the first and second images. In fact, the changes between the first and second images may be substantially eliminated from view if the second image is subtracted from the third image and the remainder image is then combined with the first image. The remainder image may alternately be combined with the third image. The remainder image may optionally be marked for increased visibility during evaluation of the image combined with the remainder image. In other words, changes may be shown as compared to the initial image state or progressive image changes may be shown to illustrate changes between intermediate images.

In a playback of a sequence of images, the first image may be shown, followed by the second image combined with the remainder image from the difference of the first and second images, followed by the third image combined with the remainder image from the difference of the second and third images. In another example playback of a sequence of images, the first image may be shown, followed by the first image combined with the remainder image from the difference of the first and second images, followed by the first image combined with the remainder image from the difference of the second and third images. In yet another example playback of a sequence of images, the first image may be shown, followed by the first image combined with the remainder image from the difference of the first and second images, followed by the first image combined with the remainder image from the difference of the first and third images, etc.

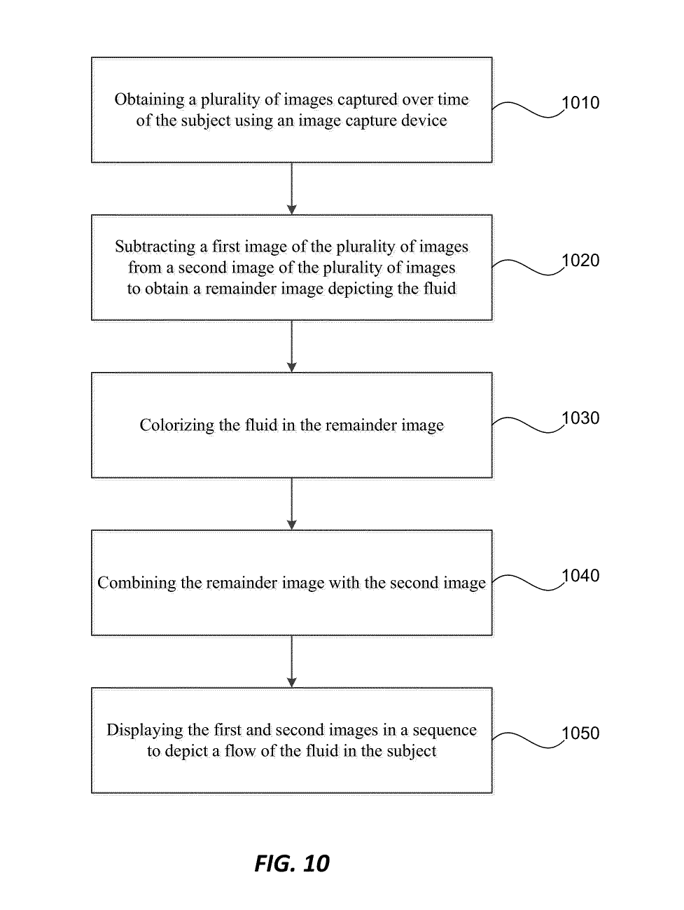

Referring to FIG. 10, an image processing method is illustrated in accordance with another example of the present technology. A fluid may be inserted into a subject. The subject may be a human being, for example, with living body tissue. The fluid may be inserted into blood vessels of the subject. The fluid may be the blood marking compound described previously. Images may be captured 1010 over time of the subject using an image capture device. The image capture may begin prior to insertion of the compound in order to have a base or reference image and may continue after insertion of the compound in order to capture images of the flow of the compound within the subject.

The method may include subtracting 1020 a first image from a second image to obtain a remainder image depicting the fluid. The fluid in the remainder image may be colorized 1030 to increase the visibility of the fluid. The remainder image may be combined 1040 with the second image. The first and second images may be displayed 1050 in a sequence to depict a flow of the fluid in the subject. For example, the sequence of images may be a video stream, where individual of the images represent a single frame in the video stream. In one example, the sequence of images may be presented similar to a slideshow where progression between images is manually performed or is performed at predetermined intervals of time.

The method may further include aligning the captured images to reduce the presence of artifacts in the remainder image and/or to facilitate improved correspondence of features in the images by a medical professional viewing the captured images. In one example, the images may be aligned by spatially co-locating common features of the plurality of images such that movement of the subject while capturing the plurality of images is compensated for and the subject appears stationary when displaying the plurality of images in sequence. The images may be aligned, for example, using intensity-based image registration, feature-based image registration and so forth. In a specific example, the images may be rigidly aligned using a least squares alignment.

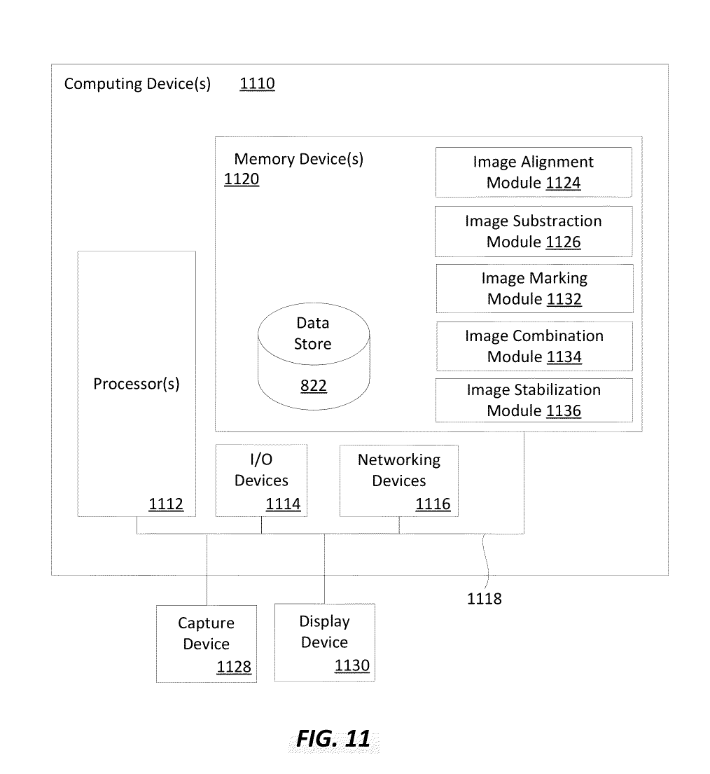

Referring to FIG. 11, a block diagram of an image registration system is illustrated in accordance with another example. The system may include an image alignment module 1124 configured to aligning a plurality of images of a subject captured over time. For example, the image alignment module 1124 may be a feature-based or intensity-based image registration module. An image subtraction module 1126 may be configured to subtract one of the plurality of images from another of the plurality of images to obtain a remainder image. An image marking module 1132 may be configured to mark the remainder image. The image marking module 1132 may optionally be a colorization module configured to colorize the remainder image. An image combination module 1134 may be configured to combine the remainder image with the second image for display.

The system may include a display device 1130 for displaying the plurality of images in a sequence to depict a flow of fluid in the subject. An image capture device 1128 may be included in the system for capturing the plurality of images. The system may also include an image stabilization module 1136 configured to stabilize the plurality of images of the subject over time such that the subject appears stationary when displayed to a user as a sequence of images.

The modules that have been described may be stored on, accessed by, accessed through, or executed by a computing device 1110. The computing device 1110 may comprise any system providing computing capability. The computing device 1110 may be embodied, for example in the form of a client computer, a desktop computer, a laptop computer, a mobile device, a hand held messaging device, a set-top box, heads up display (HUD) glasses, a car navigation system, personal digital assistants, cellular telephones, smart phones, set-top boxes, network-enabled televisions, music players, web pads, tablet computer systems, game consoles, electronic book readers or other devices with like capability, including capabilities of receiving and presenting content from a server. The computing device 1110 may include a display 1130. The display 1130 may comprise, for example, one or more devices such as cathode ray tubes (CRTs), liquid crystal display (LCD) screens, gas plasma based flat panel displays, LCD projectors, or other types of display devices, etc.

In one aspect, a plurality of computing devices may be employed that are arranged, for example, in one or more server banks, blade servers or other arrangements. For example, a plurality of computing devices together may comprise a cloud computing resource, a grid computing resource, and/or any other distributed computing arrangement. Such computing devices may be located in a single installation or may be distributed among many different geographical locations. For purposes of convenience, the computing device 1110 is referred to herein in the singular form. Even though the computing device 1110 is referred to in the singular form, however, it is understood that a plurality of computing devices may be employed in the various arrangements described above.

Various applications and/or other functionality may be executed in the computing device 1110 according to various embodiments, which applications and/or functionality may be represented at least in part by the modules that have been described. Also, various data may be stored in a data store 1122 that is accessible to the computing device. The data store 1122 may be representative of a plurality of data stores as may be appreciated. The data stored in the data store 1122, for example, is associated with the operation of the various applications and/or functional entities described. The components executed on the computing device 1110 may include the modules described, as well as various other applications, services, processes, systems, engines or functionality not discussed in detail herein.

The term “data store” may refer to any device or combination of devices capable of storing, accessing, organizing and/or retrieving data, which may include any combination and number of data servers, relational databases, object oriented databases, simple web storage systems, cloud storage systems, data storage devices, data warehouses, flat files and data storage configuration in any centralized, distributed or clustered environment. The storage system components of the data store may include storage systems such as a SAN (Storage Area Network), cloud storage network, volatile or non-volatile RAM, optical media or hard-drive type media.

The computing device 1110 may be representative of a plurality of local client devices that may be coupled to a network. The client devices may communicate over any appropriate network, including an intranet, the Internet, a cellular network, a local area network (LAN), a wide area network (WAN), a wireless data network or a similar network or combination of networks.

Although a specific structure may be described herein that defines server-side roles (e.g., roles of the management device) and client-side roles (e.g., roles of the local computing device), it is understood that various functions may be performed at the server side or the client side.

Certain processing modules may be discussed in connection with this technology. In one example configuration, a module may be considered a service with one or more processes executing on a server or other computer hardware. Such services may be centrally hosted functionality or a service application that may receive requests and provide output to other services or customer devices. For example, modules providing services may be considered on-demand computing that is hosted in a server, cloud, grid or cluster computing system. An application program interface (API) may be provided for each module to enable a second module to send requests to and receive output from the first module. Such APIs may also allow third parties to interface with the module and make requests and receive output from the modules. Third parties may either access the modules using authentication credentials that provide on-going access to the module or the third party access may be based on a per transaction access where the third party pays for specific transactions that are provided and consumed.

The computing device 1110 may include one or more processors 1112 that are in communication with memory devices 1120. One or more processors may, for example, include single or multi-core central processing units (CPUs) or graphics processing units (GPUs). In some example implementations, use of GPUs for processing the images may result in substantially reduced processing times due to the large number of processing units available on a graphics card as compared with the number of processors in many CPUs. The computing device 1110 may include a local communication interface for the components in the computing device 1110. For example, the local communication interface may be a local data bus 1118 and/or any related address or control busses as may be desired.

The memory device 1120 may contain modules that are executable by the processor(s) and data for the modules. Located in the memory device 1120 are modules executable by the processor 1112. The data store 1122 may also be located in the memory device 1120 for storing data related to the modules and other applications along with an operating system that is executable by the processor(s) 1112.

Various applications may be stored in the memory device and may be executable by the processor(s) 1112. Components or modules discussed in this description that may be implemented in the form of software using high programming level languages that are compiled, interpreted or executed using a hybrid of the methods.

The computing device 1110 may also have access to I/O (input/output) devices 1114 that are usable by the computing devices 1110. An example of an I/O device 1114 is a display screen that is available to display output from the computing devices. Other known I/O devices 1114 may be used with the computing device 1110 as desired. Networking devices 1116 and similar communication devices may be included in the computing device 1110. The networking devices 1116 may be wired or wireless networking devices that connect to the internet, a LAN, WAN, or other computing network.

The components or modules that are shown as being stored in the memory device 1120 may be executed by the processor 1112. The term “executable” may mean a program file that is in a form that may be executed by a processor. For example, a program in a higher level language may be compiled into machine code in a format that may be loaded into a random access portion of the memory device and executed by the processor, or source code may be loaded by another executable program and interpreted to generate instructions in a random access portion of the memory to be executed by a processor. The executable program may be stored in any portion or component of the memory device. For example, the memory device may be random access memory (RAM), read only memory (ROM), flash memory, a solid state drive, memory card, a hard drive, optical disk, floppy disk, magnetic tape, or any other memory components.

The processor 1112 may represent multiple processors and the memory may represent multiple memory units that operate in parallel to the processing circuits. This may provide parallel processing channels for the processes and data in the system. The local interface may be used as a network to facilitate communication between any of the multiple processors and multiple memories. The local interface may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology. As used herein, the terms “medium” and “media” may be interchangeable with no intended distinction of singular or plural application unless otherwise explicitly stated. Thus, the terms “medium” and “media” may each connote singular and plural application.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

1. An image processing method, comprising
obtaining a plurality of images of a subject captured using an image capture device;
aligning the plurality of images;
subtracting a first image of the plurality of images from a second image of the plurality of images to obtain a remainder image;
marking the remainder image; and
combining the remainder image with the second image.

2. The method of claim 1, wherein combining the remainder image with the second image comprises overlaying the remainder image on the second image.

3. The method of claim 1, wherein the plurality of images includes at least three images, the method further comprising: subtracting the first image from a third image of the plurality of images to obtain a second remainder image; marking the second remainder image; and combining the second remainder image with the third image.

4. The method of claim 1, wherein the plurality of images includes at least three images, the method further comprising: subtracting the second image from a third image of the plurality of images to obtain a second remainder image; marking the second remainder image; and combining the second remainder image with the third image.

5. The method of claim 1, wherein marking the remainder image comprises colorizing the remainder image.

6. An image processing method for processing images of a fluid inserted in a subject, comprising:
obtaining a plurality of images captured over time of the subject using an image capture device;
subtracting a first image of the plurality of images from a second image of the plurality of images to obtain a remainder image depicting the fluid;
colorizing the fluid in the remainder image;
combining the remainder image with the second image; and
providing the first and second images in a sequence for display to depict a flow of the fluid in the subject.

7. The method of claim 6, wherein the subject comprises living body tissue.

8. The method of claim 6, wherein the plurality of images comprise frames of a video.

9. The method of claim 6, further comprising aligning the plurality of images.

10. The method of claim 9, wherein aligning the plurality of images comprises spatially co-locating common features of the plurality of images such that movement of the subject while capturing the plurality of images is compensated and the subject appears stationary when displaying the plurality of images in sequence.

11. The method of claim 9, wherein aligning the plurality of images comprises aligning the plurality of images using intensity-based image registration.

12. The method of claim 9, wherein aligning the plurality of images comprises aligning the plurality of images using feature-based image registration.

13. The method of claim 9, wherein aligning the plurality of images comprises rigidly aligning the plurality of images using a least squares alignment.

14. An image registration system, comprising:
an image alignment module to align a plurality of images of a subject captured over time;
an image subtraction module to subtract one of the plurality of images from another of the plurality of images to obtain a remainder image;
an image marking module to mark the remainder image; and
an image combination module to combine the remainder image with the second image for display.

15. The system of claim 14, further comprising an image capture device for capturing the plurality of images.

16. The system of claim 14, wherein the image alignment module comprises a feature-based image registration module.

17. The system of claim 14, wherein the image alignment module comprises an intensity-based image registration module.

18. The system of claim 14, wherein the image marking module comprises a colorization module configured to colorize the remainder image.

19. The system of claim 14, further comprising an image stabilization module configured to stabilize the plurality of images of the subject over time such that the subject appears stationary when displayed to a user as a sequence of images.

20. The system of claim 14, further comprising a display device for displaying the plurality of images in a sequence to depict a flow of fluid in the subject.

21. An image alignment method, comprising:
obtaining at least thousands of images over a period of time of a subject where the subject has movement during the period of time;
identifying a base image among the at least thousands of images for comparison against a remainder of the at least thousands of images;
comparing the remainder against the base image;
aligning the remainder with the base image when comparison of the remainder and the base image indicates the movement; and
subtracting the base image from each of the images in the remainder to identify changes in the remainder from the base image.

22. The method of claim 21, wherein aligning the remainder comprises aligning the remainder using a least squares image registration.

23. The method of claim 22, wherein the least squares image registration includes at least one of translation, rotation and scaling of the base or remainder images.

24. The method of claim 21, wherein the method is performed using a graphics processing unit (GPU).
